(19) United States
(12) Patent Application Publication
(10) Pub. No.: US 2026/0170707 A1
(43) Pub. Date: Jun. 18, 2026

(54) METHOD AND DEVICE WITH PERSONALIZED IMAGE GENERATION

(71) Applicants: SAMSUNG ELECTRONICS CO., LTD., Suwon-si (KR); UIF (University Industry Foundation), Yonsei University, Seoul (KR)

(72) Inventors: Sehwan KI, Suwon-si (KR); Daekyu KWON, Seoul (KR); Dongyoung KIM, Seoul (KR); Younghyun JO, Suwon-si (KR); Eunhee KANG, Suwon-si (KR); Seon Joo KIM, Seoul (KR); Jisoo SON, Suwon-si (KR); Hyong Euk LEE, Suwon-si (KR)

(73) Assignees: SAMSUNG ELECTRONICS CO., LTD., Suwon-si (KR); UIF (University Industry Foundation), Yonsei University, Seoul (KR)

(21) Appl. No.: 19/276,509

(22) Filed: Jul. 22, 2025

(30) Foreign Application Priority Data
Dec. 16, 2024 (KR) 10-2024-0187604

(51) Int. Cl. G06T 11/00; G06N 3/0985

(52) U.S. Cl. CPC G06T 11/00; G06N 3/0985; G06T 2211/441

(57) ABSTRACT

A method and device with personalized image generation are provided. The method includes generating a preference vector of a user based on a plurality of preset properties for personalized image generation, generating a personalized image for the user based on the preference vector and a connection relationship between an image generative model and a plurality of characterization layers corresponding to the plurality of properties, and outputting the personalized image in response to an image generation command.

### CROSS-REFERENCE TO RELATED APPLICATIONS

This application claims the benefit under 35 USC § 119(a) of Korean Patent Application No. 10-2024-0187604, filed on Dec. 16, 2024, in the Korean Intellectual Property Office, the entire disclosure of which is incorporated herein by reference for all purposes.

### BACKGROUND

### 1. Field

The following description relates to a method and device with personalized image generation.

### 2. Description of Related Art

In the field of artificial intelligence (AI), text-to-image generative models may generate images based on input text. An image that people prefer may be generated based on given text. A data set may be built and the data set may be fed into a specific deep learning model.

Typically, a data set may be built first and the specific deep learning model may be trained by feeding the data set into the model. In this case, user preference information may be collected mainly through user studies and a data set built based on the collected data may be used to develop models that generate images in line with user preferences, employing techniques such as reinforcement learning or direct policy optimization.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes generating a preference vector of a user based on a plurality of properties predetermined for personalized image generation; generating the personalized image for the user based on the preference vector and a connection relationship between an image generative model and a plurality of characterization layers corresponding to the plurality of properties; and outputting the personalized image in response to an image generation command.

The generating of the personalized image for the user may include applying input data applied to a first layer included in the image generative model to a first characterization layer connected to the first layer in parallel, according to the connection relationship; determining a weight of the first characterization layer according to the preference vector; and aggregating an output of the first layer and an output of the first characterization layer based on the weight and transmitting an aggregated output to a next layer.

The method may further include applying the input data applied to the first layer included in the image generative model to a second characterization layer connected to the first layer in parallel, according to the connection relationship; determining a weight of the second characterization layer according to the preference vector; and aggregating an output of the first layer and an output of the second characterization layer based on the weight and transmitting an aggregated output to the next layer.

The plurality of characterization layers may include one or more of a layer trained to maximize a score of a brightness property for an output of the image generative model for an arbitrary text input; a layer trained to maximize a score of a saturation property for an output of the image generative model for the arbitrary text input; a layer trained to maximize a score of a contrast property for an output of the image generative model for the arbitrary text input; and a layer trained to maximize a score of an edge sharpness property for an output of the image generative model for the arbitrary text input.

The generating of the preference vector may include providing the user with a plurality of images generated with different weights with respect to the plurality of characterization layers; and causing the user to select one from the plurality of images, thereby updating the preference vector.

Each of the plurality of characterization layers may be trained to maximize a score of a property for an image output by the image generative model according to the property.

During the training of the plurality of characterization layers, a parameter of the image generative model may be fixed.

The method may further include receiving the image generation command that is input via text or voice.

In one general aspect, a processor-implemented method of training a characterization layer for personalized image generation includes training a preference prediction model based on a preference data set; generating an output image corresponding to an image generation command from an image generative model based on a connection relationship between the image generative model and a characterization layer corresponding to one of a plurality of properties; determine a score of a property for the output image using the preference prediction model; and training a parameter of the characterization layer to maximize the score of the property.

The training of the parameter of the characterization layer may include fixing a parameter of the image generative model.

The preference data set may include a plurality of images output by the image generative model and the score of the property labeled on the plurality of images.

The training of the parameter of the characterization layer may include training the parameter of the characterization layer using one or more data sets of Pick-a-Pic, Human Preference Score, ImageReward, and CLIP-Aesthetics.

The training of the parameter of the characterization layer may include any one or any combination of any two or more of training the parameter of the characterization layer to maximize a score of a brightness property for an output of the image generative model; training the parameter of the characterization layer to maximize a score of a saturation property for the output of the image generative model; training the parameter of the characterization layer to maximize a score of a contrast property for the output of the image generative model; and training the parameter of the characterization layer to maximize a score of an edge sharpness property for the output of the image generative model.

In one general aspect, provided is a non-transitory computer-readable storage medium storing code that, when executed by one or more processors, configures the one or more processors to perform the method described herein.

In one general aspect, a device includes one or more processors configured to generate a preference vector of a user based on a plurality of properties predetermined for personalized image generation; generate a personalized image for the user based on the preference vector and a connection relationship between an image generative model and a plurality of characterization layers corresponding to the plurality of properties; and output the personalized image in response to an image generation command.

The one or more processors may be further configured to applying input data applied to a first layer comprised in the image generative model to a first characterization layer connected to the first layer in parallel, according to the connection relationship; determining a weight of the first characterization layer according to the preference vector; and aggregating an output of the first layer and an output of the first characterization layer based on the weight and transmitting an aggregated output to a next layer.

The one or more processors may be further configured to: apply the input data applied to the first layer comprised in the image generative model to a second characterization layer connected to the first layer in parallel, according to the connection relationship; determine a weight of the second characterization layer according to the preference vector; and aggregate an output of the first layer and an output of the second characterization layer based on the weight and transmit an aggregated output to the next layer.

The one or more processors may be further configured to receive the image generation command that is input via text or voice.

The preference vector may be set by phases by repeating providing the user with a plurality of images generated with different weights with respect to the plurality of characterization layers; and causing the user to select one from the plurality of images.

Other features and aspects will be apparent from the following detailed description, the drawings, and the claims.

### BRIEF DESCRIPTION OF THE DRAWINGS

FIG. 1 is a diagram illustrating an example configuration and operation with personalized image generation according to one or more embodiments.

FIG. 2 is a flowchart illustrating an example method with personalized image generation according to one or more embodiments.

FIG. 3 illustrates an example method of setting a preference vector according to one or more embodiments.

FIG. 4 illustrates an example configuration of a characterization layer according to one or more embodiments.

FIG. 5 is a flowchart illustrating an example method of training characterization layers according to one or more embodiments.

FIG. 6 is a diagram illustrating an example of training a preference prediction model according to one or more embodiments.

FIG. 7 is a diagram illustrating an example training method of a characterization layer according to one or more embodiments.

FIG. 8 is a block diagram illustrating an example device for generating a personalized image according to one or more embodiments.

FIG. 9 is an example output image in which a preference vector is reflected according to a user, according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

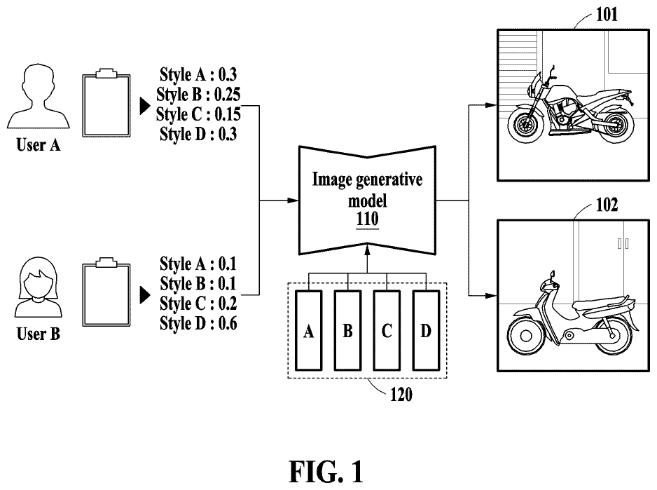

FIG. 1 is a diagram illustrating an example configuration and operation with personalized image generation according to one or more embodiments.

Typically, an image generative model that reflects preferences of a user may be implemented by fine-tuning an image generative model using a data set that reflects general or universal preferences. However, because such universal preferences do not match individual user preferences, this typical approach may not be an appropriate approach. Further, collecting a personalized data set and training the model may cause the implementation of an image generative model inefficient in terms of time and computational resources.

In one or more embodiments, a pre-trained image generative model 110 and pre-trained characterization layers 120 may be used to reflect preference information of each of a plurality of users. This configuration may generate an output image that reflects the preference information of the user from the image generative model 110.

The image generative model 110 may be trained to generate a result image in response to an image generation command provided as text or voice input. For example, in response to the input command of “a cat image”, the model may be trained to generate and output an image that includes a cat.

When outputting an image from the image generative model 110, the preference of the user may not be reflected. To address this, the pre-trained characterization layers 120 may be connected in parallel to the image generative model 110, enabling the generation of a personalized image that reflects the user's preference. In this case, when training the characterization layers 120, universal user preferences may be reflected using a generative artificial intelligence (AI) assessment methodology.

The characterization layers 120 may include a plurality of independent low rank adaptation (LoRA) modules. Each LoRA module may be trained to reflect a plurality of image features. For example, a module A may include a plurality of layers for adjusting image brightness, a module B may include a plurality of layers for controlling image saturation, and a module C may include a plurality of layers for modifying image contrast.

The trained characterization layers 120 may be connected to the image generative model 110 in parallel and respective weights may be determined based on preference vectors that are preset for each user. For example, as illustrated in FIG. 1, user A may have a preference vector indicating style weights of 0.3, 0.25, 0.15, and 0.3 for styles A through D, respectively, such that the weights sum to 1. User B, on the other hand, may have a preference vector of 0.1, 0.1, 0.2, and 0.6 for the same styles. These preference vectors may be derived through a research process on the user, where the user is repeatedly presented with multiple images and asked to select one or more preferred images, allowing the preference vector to converge over time to accurately reflect user preferences.

Even if the users A and B input an same image generation command, such as “motorcycle image,” different images may be generated/output based on their respective preference vectors and respective connection relationships between the image generative model 110 and the characterization layers 120. For example, an image 101 may be generated based on user A's preference vector in which styles A through D are 0.3, 0.25, 0.15, and 0.3, respectively, and an image 102 may be generated based on user B's preference vector in which styles A through D are 0.1, 0.1, 0.2, and 0.6, respectively.

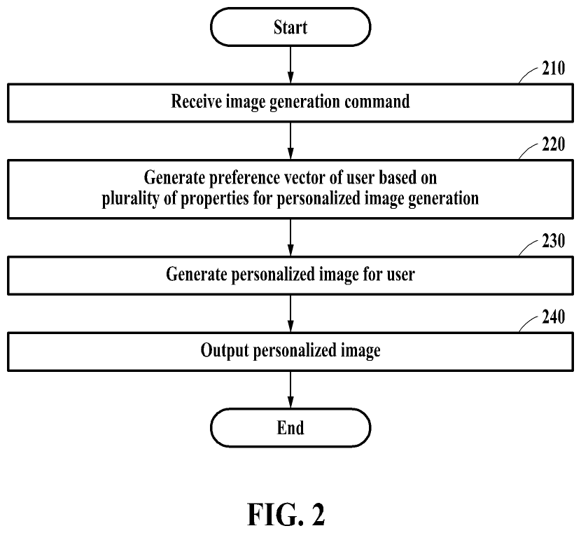

FIG. 2 is a flowchart illustrating an example operation method with personalized image generation according to one or more embodiments.

In one or more embodiments, operations may be performed sequentially, but not necessarily performed sequentially. For example, operations may be performed in different orders than shown or described, and two or more operations may be performed in parallel.

In operation 210, a device may receive an image generation command.

The device may receive the image generation command input by a user via a user interface (UI) of the device. For example, the image generation command may be provided in the form of text or voice. The image generation command may be received from a wirelessly connected device or an external source. The origin of the command is not limited to the user.

In operation 220, the device may obtain a preference vector of the user based on a plurality of preset image properties to personalize image generation process.

The plurality of properties may represent various image characteristics, such as brightness, contrast, saturation, and sharpness. The preference vector may vary depending on the user and the preference vector may be set differently for each user depending on the process used to establish the preference vector. The preference vector may include respective weights of the plurality of characterization layers associated with respective properties of the image output by the image generative model. Each weight may be represented as a value between 0 and 1, with a higher value indicating a stronger user preference for a given property.

In operation 230, the device may generate a personalized image for the user based on the preference vector and the connection relationship between the image generative model and the plurality of characterization layers corresponding to the plurality of image properties.

An image may be generated by a pre-trained image generative model. The image generated by the image generative model may be processed through the characterization layers, each corresponding to one of the plurality of properties. A preference vector may be applied to an output of each characterization layer to reflect user-specific preferences.

The LoRA module may be applied to each characterization layer. The LoRA module may be an approach method of efficiently training a large-scale model at a relatively low cost and may enable fine-tuning of the large-scale model by training parameters of the LoRA module without retraining the entire large-scale model. This approach significantly reduces the computational cost associated with model customization by updating only a few parameters of the LoRA module.

To reflect each property of the image using the LoRA module, a personalized image may be generated by training one LoRA module for one property and simultaneously using the trained LoRA modules. The personalized image may be generated by a weighted sum of results of the LoRA modules by applying the preset preference vector to each LoRA module.

To enable this, the LoRA modules may be connected to the image generative model in parallel. Each LoRA module may include a plurality of layers connected in parallel to the corresponding layers of the image generative model. The LoRA module for each property may include layers connected to at least one layer of the image generative module in parallel according to a trained parameter and the same weight may be applied to the layers of the LoRA module with the corresponding property according to the determined preference vector.

A final personalized image may be generated by a weighted sum of outputs of the characterization layers connected in parallel to the image generative model, according to the preference vector.

In operation 240, the device may output the personalized image in response to the image generation command.

The generated image may be output via an output device, such as a display. In one or more embodiments where the device may be implemented as a server, the generated image may be transmitted to a user terminal for visual output.

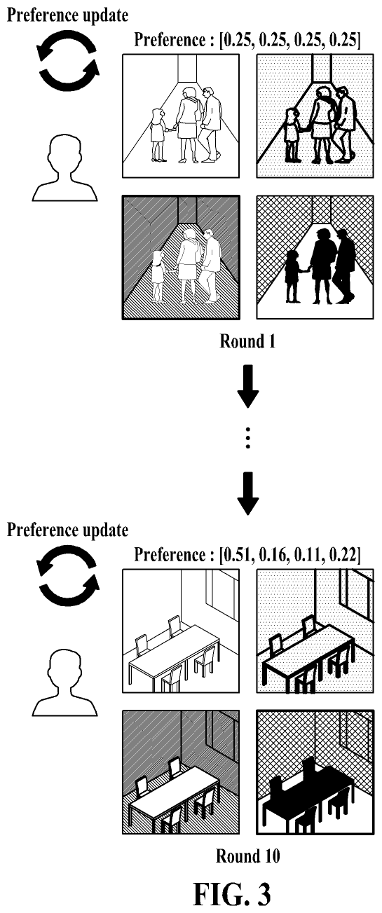

FIG. 3 illustrates an example method of setting a preference vector according to one or more embodiments.

The method may be performed by a device configured to generate images or, by a separate device prior to image generation.

A device may provide a plurality of images to a user through multiple steps (e.g., 10 steps as illustrated in FIG. 3) to determine a final preference vector. The provided images may be similar in content but differ in one or more properties. Each image may be associated with a corresponding preference vector. A preference vector associated with an image selected by the user at a first step may be used as a reference preference vector.

Thereafter, a plurality of images provided in a second step may be different from the images provided in the first step, with each image of the second step having a distinct preference vector. The device may update or refine a value of the first (reference) preference vector based on a preference vector of an image selected by the user in the second step. For example, a mean of the preference vectors may be determined or a weighted sum may be obtained according to weights.

Images presented in the second step may be determined based on the image selected in the first step. For example, images may be filtered to expose only those in the second step, whose associated preference vectors fall within a predetermined error range based on the preference vector of the first selected image.

The device may repeatedly perform providing an image and receiving user selection to progressively investigate the preference vector for the user and may set a final preference vector by updating the preference vector for each step. The repetition may be performed by a predetermined number (e.g., 10 as illustrated in FIG. 3) and the final preference vector may be stored in correspondence with the user.

When a range of a preference value is defined between 0 and 1, a change in weight (Δ) during the preference survey (i.e., a preference setting process) may be represented as a decimal constant between 0 and 1. The value of Δ may be determined using a predefined prediction function, such as Δ=f(x₁) or Δ=f(x₁, x₂), where x₁ represents a previous preference value and x₂ represents preference survey round (i.e., the iteration number in the preference setting process).

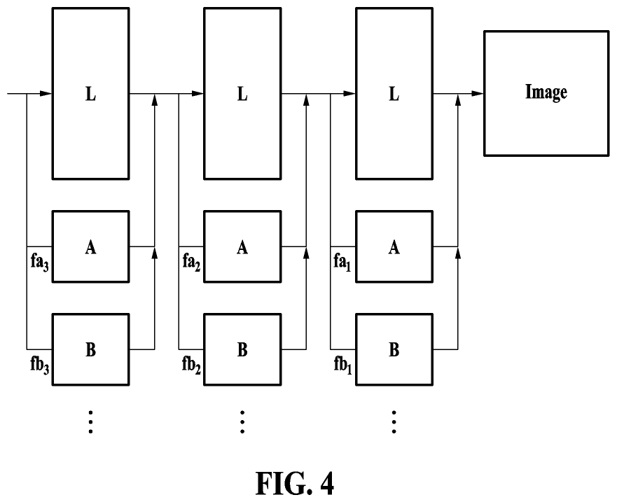

FIG. 4 illustrates an example configuration of a characterization layer according to one or more embodiments.

In one or more embodiments, it may be assumed that an image generative model comprises a structure in which multiple layers are connected in sequence. A characterization layer may include a layer connected in parallel to a corresponding one of a plurality of layers L of the image generative model. In one configuration, each characterization layer may be connected in parallel to a single layer of the generative model. In another configuration, the characterization layer may be connected in parallel to all layers of the image generative model and a parameter for a property may be trained for each layer.

As illustrated, a set of characterization layers for a property A may be connected to the image generative model in parallel and another set of characterization layers for a property B may also be connected to the image generative model in parallel.

The characterization layers for the property A and the characterization layers for the property B may be separately trained. During training of the characterization layers for the property A, parameters of the characterization layers may be simultaneously trained so that an output image of the image generative model represents the property A while the characterization layers for the property A are connected to the image generative model in parallel. During this training phase, characterization layers for other properties (e.g., property B) may not be connected. The image generative model may be a pre-trained model and a parameter of the image generative model may be fixed while training the characterization layers.

Similarly, when training the characterization layers for the property B, the characterization layers for the property B may be connected to the image generative model in parallel and may train parameters of the characterization layers for the property B so that an output image of the image generative model represents the property B. During the training of the characterization layers, the parameter of the image generative model may be fixed.

In response to receiving an image generation command, an image may be generated using the preference vector set according to the user. For example, when the preference vectors of the properties A and B are [0.7, 0.3], respectively, characterization layers 0.7fa₁+0.3fb₁, 0.7fa₂+0.3fb₂, and 0.7fa₃+0.3fb₃ may be reflected in each layer L of the image generative model.

The characterization layers for reflecting two or more properties in the image generated by the image generative model may be connected to the image generative model in parallel and the image may be generated based on the preference vector reflected in each characterization layer.

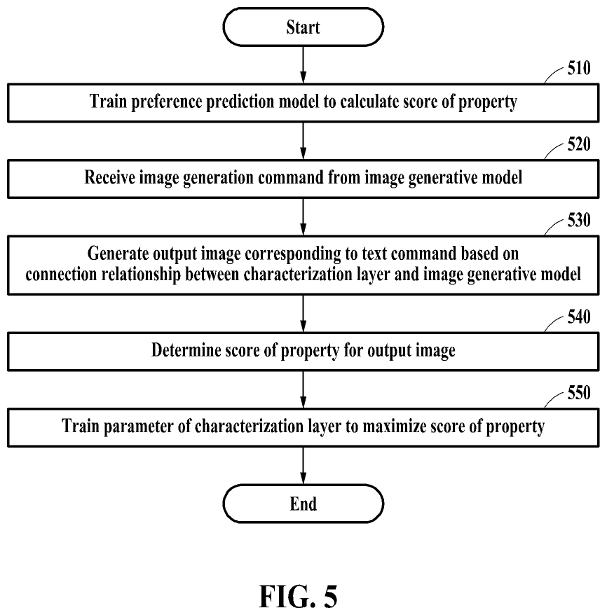

FIG. 5 is a flowchart illustrating an example method of training characterization layers according to one or more embodiments.

Each characterization layer may be trained by a device for training. As described above, the characterization layers indicating one property may be trained independently from characterization layers indicating another property. The characterization layer trained below may be configured to represent one property.

In operations 510, the device may train a preference prediction model configured to determine a score for one of a plurality of properties based on a preference data set.

Prior to training the characterization layers, the preference prediction model may be trained to evaluate a property of an image generated by the image generative model. The preference prediction model may implement an AI-based image quality assessment model, such as an AI-Generated Content Image Quality Assessment (AIGC IQA), to assess an output image generated by the image generative model.

The preference prediction model may be trained by receiving a text prompt used for generating an image and an image generated in response to the text prompt and assessing the preference of the image. In this case, the preference prediction model may be trained according to a preference data set in which a score for a property is labeled in advance based on the property. As the preference prediction model depends on a property of the data set used for training, the preference prediction model may be trained to reflect a score of another universal property for each property.

The trained preference prediction model may receive a text prompt for generating an image and the generated image in response to the text prompt as input, and output a score representing the image's expression based on the property.

Alternatively, the trained preference prediction model may be obtained and used to train the characterization layers.

In operation 520, the device may receive an image generation command from the image generative model.

The image generation command may be in the form of text data, which may correspond to converted data from a text input or a voice input.

In operation 530, the device may obtain an output image corresponding to the text command based on a connection relationship between the characterization layer and the image generative model.

The characterization layer may be selected from the plurality of characterization layers and may be connected to the image generative model as described with reference to FIG. 4. The image generative model may use a pre-trained model, such as a text-to-image AI model (e.g., Stable Diffusion). However, the approach is not limited to the image generative model and may be a model that generates video or audio content. When training the characterization layer, a parameter of the image generative model may remain fixed.

In operation 540, the device may determine a score of a property for the output image using the preference prediction model.

The preference prediction model may receive text data corresponding to the image generation command and an output image corresponding thereto as inputs and may output a score of the property of the output image. For example, a saturation property score for the output image may be output using the preference prediction model trained for the saturation property.

In operation 550, the device may train a parameter of the characterization layer to maximize the score of the property.

The characterization layer may train an LoRA module by backpropagating to increase the score of the property.

For training purposes, various data sets may be used, including: “Pick-a-Pic” (for image preference selection), human preference score related to subjective aesthetic quality prediction, “ImageReward” (for image quality assessment and enhancement), and “CLIP-Aesthetics” (for CLIP-based image quality assessment).

To train the characterization layer, a weight of a training result image generative model may remain unchanged, and LoRA modules in which properties are reflected based on each data set may be added to the image generative model.

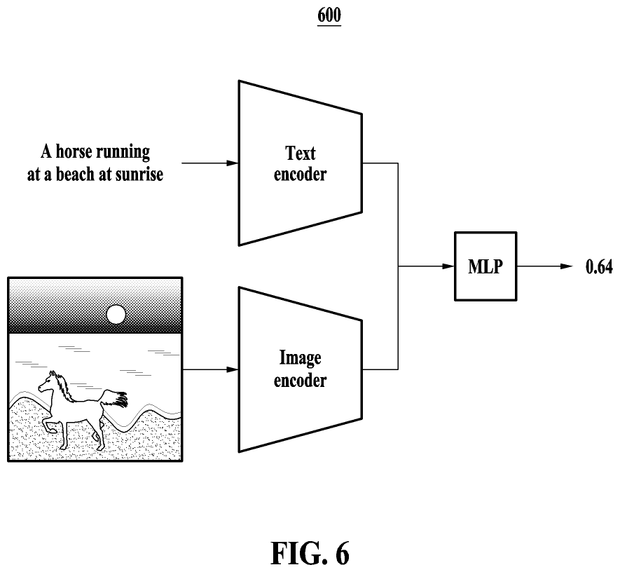

FIG. 6 is a diagram illustrating an example of training a preference prediction model according to one or more embodiments.

A preference prediction model 600 may receive a text prompt and a generated image in response thereto as inputs. Each input may pass and be processed through a respective text encoder for the prompt and an image encoder for the image. and may be trained to output a score for a property through an artificial neural network that is advantageous to supervise learning, such as multi-layer perceptron (MLP).

A preference data set for training may include data in which scores for properties are labeled to reflect universal properties. A data set targeting the universal majority may be secured to train the preference prediction model 600. Accordingly, the preference prediction model 600 may be trained using backpropagation and gradient descent based on an error between the preference data set and an output score.

Because the preference prediction model 600 is trained using a data set labeled based on one property, the preference prediction model 600 may output a score for the trained property. Accordingly, multiple preference prediction models may be trained using respective preference data sets for different properties. Each of these trained models may be used as a reference or evaluation criterion for training the corresponding characterization layers.

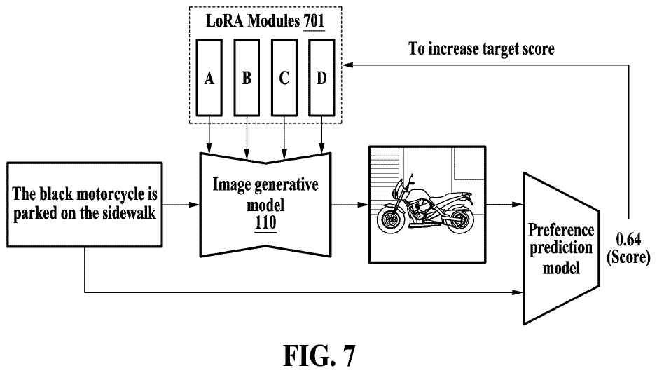

FIG. 7 is a diagram illustrating an example training method of a characterization layer according to one or more embodiments.

Characterization layers 701 may be implemented using LoRA modules. Each LoRA module may be connected in parallel to an image generative model to reflect respective (e.g., properties A through D) properties in an output image.

The characterization layers 701 may be trained independently for each property. For example, to train a LoRA module for property A, only the module corresponding to property A may be connected to the image generative model, while modules for properties B through D may remain disconnected. Similarly, when training the LoRA module for property B, the LoRA modules for properties A, C, and D may not be connected to the image generative model.

The preference prediction model may be trained in accordance with the method illustrated in FIG. 6, and may be configured to receive a text prompt and a corresponding generated image as inputs and to output a score based on a property for training. For example, the preference prediction model trained for the saturation property may output a score for the saturation property by receiving a text prompt and an image generated in response thereto. Accordingly, the preference prediction model trained for the saturation property may be used to assess images for their saturation level, and such a model may be used to train a characterization layer for the saturation property.

Each characterization layer may be trained by adjusting its parameters via backpropagation to increase a score of a corresponding property output by the preference prediction model. Through iterative training, the characterization layer may be optimized to generate an image that receives a higher score from the preference prediction model. In this case, training may be performed on parameters of a characterization layer connected to the image generative model rather than the image generative model.

The above training method may be repeated for each property of interest, thereby generating a corresponding characterization layer for each property. In such cases, different preference prediction models—each trained for a different property—may be applied accordingly to guide the training of their respective characterization layers.

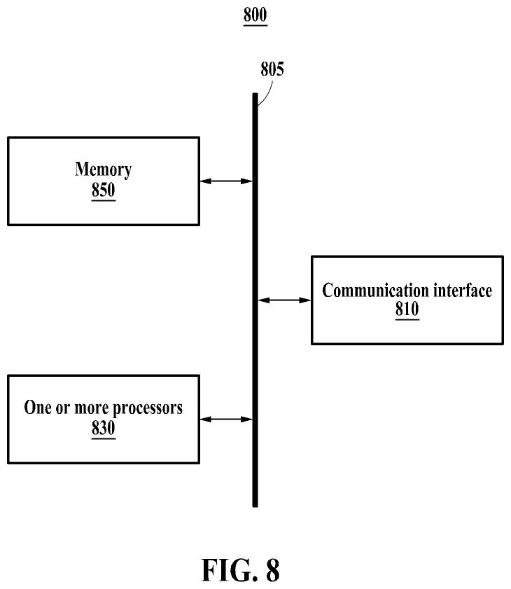

FIG. 8 is a block diagram illustrating an example device for generating an image according to one or more embodiments.

Referring to FIG. 8, a device 800 of one or more embodiments may include a communication interface 810, one or more processors 830, and a memory 850. The communication interface 810, the one or more processors 830, and the memory 850 may communicate with one another via a communication bus 805.

The communication interface 810 may receive an image generation command.

The communication interface 810 may support wired and/or wireless data transmission and reception. For example, the communication interface 810 may include a wireless interface such as Wi-Fi, Bluetooth, Zigbee, and/or long range (LoRa), a wired interface such as Ethernet, Universal Serial Bus (USB), and/or near-field communication (NFC).

The communication interface 810 may include a user interface configured to receive input from a user.

The one or more processors 830 may generate an image based on the command received via the communication interface 810. The one or more processors 830 may generate an image reflecting a user's preference by applying a preference vector of the user corresponding to the image generation command. For example, a weight of each characterization layer may be reflected in an output image of an image generative model by applying a preference vector of at least one characterization layer connected to the pre-trained image generative model.

The memory 850 may store various types of information generated during an encoding process and may store programs executable by the one or more processors 830. In addition, the memory 850 may store a variety of data and programs necessary for operation. The memory 850 may include volatile memory, non-volatile memory, or a combination thereof. The memory 850 may include a large-capacity storage medium such as a hard disk to store a variety of data.

In addition, the one or more processors 830 may perform one or more methods described above with reference to FIGS. 1 through 7, or an algorithm corresponding to the one or more methods. The one or more processors 830 may comprise a data processing device implemented by hardware including a physical circuit structure designed to perform desired operations. Such operations may include the execution of code or instructions included in a program. The one or more processors 830 may be implemented as, for example, a central processing unit (CPU), a graphics processing unit (GPU), or a neural network processing unit (NPU). Further examples of the one or more processors 830 may include a microprocessor, a processor core, a multi-core processor, a multiprocessor, an application-specific integrated circuit (ASIC), and a field-programmable gate array (FPGA).

The one or more processors 830 may execute a program code to control operations of the device 800. Program codes to be executed by the one or more processors 830 may be stored in the memory 850.

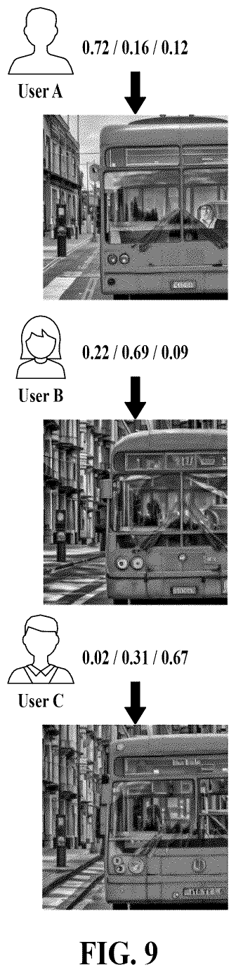

FIG. 9 illustrates an example of an output image in which a preference vector is reflected according to a user, according to one or more embodiments.

An image may be generated by a device that includes an image generative model connected to trained characterization layers.

For users A, B, and C, preference vectors corresponding to brightness, sharpness, and color may be set as 0.72/0.1/0.12, 0.22/0.69/0.09, and 0.02/0.31/0.67, respectively. The preference vector of each user may be obtained in advance through a preference survey process or may be determined based on a record that is input when generating an image.

Since user A places high importance on brightness, the device may generate an image representing a high brightness level, for example, by erasing shadows on a road and enhancing reflected light from the top of a bus.

Since user B prioritizes sharpness, the device may generate an image representing a high sharpness level, for example, by generating multiple straight structural shapes on the front surface of a bus and a background building.

Additionally, since user C prioritizes color representation, the device may generate an image in which colors are more vividly represented for the background building and various colors are added to the front surface of the bus.

The electronic devices, processors, memory, storage devices, encoders, electronic device 800, processors 830, memory 850, communication interface 810, and other apparatuses, devices, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processor-implemented method of generating a personalized image, the method comprising:
generating a preference vector of a user based on a plurality of properties predetermined for personalized image generation;
generating the personalized image for the user based on the preference vector and a connection relationship between an image generative model and a plurality of characterization layers corresponding to the plurality of properties; and
outputting the personalized image in response to an image generation command.

2. The method of claim 1, wherein the generating of the personalized image for the user comprises:
applying input data applied to a first layer included in the image generative model to a first characterization layer connected to the first layer in parallel, according to the connection relationship;
determining a weight of the first characterization layer according to the preference vector; and
aggregating an output of the first layer and an output of the first characterization layer based on the weight and transmitting an aggregated output to a next layer.

3. The method of claim 2, further comprising:
applying the input data applied to the first layer included in the image generative model to a second characterization layer connected to the first layer in parallel, according to the connection relationship;
determining a weight of the second characterization layer according to the preference vector; and
aggregating an output of the first layer and an output of the second characterization layer based on the weight and transmitting an aggregated output to the next layer.

4. The method of claim 1, wherein the plurality of characterization layers comprises any one or any combination of any two or more of:
a layer trained to maximize a score of a brightness property for an output of the image generative model for an arbitrary text input;
a layer trained to maximize a score of a saturation property for an output of the image generative model for the arbitrary text input;
a layer trained to maximize a score of a contrast property for an output of the image generative model for the arbitrary text input; and
a layer trained to maximize a score of an edge sharpness property for an output of the image generative model for the arbitrary text input.

5. The method of claim 1, wherein the generating of the preference vector comprises:
providing the user with a plurality of images generated with different weights with respect to the plurality of characterization layers; and
causing the user to select one from the plurality of images, thereby updating the preference vector.

6. The method of claim 1, wherein each of the plurality of characterization layers is trained to maximize a score of a property for an image output by the image generative model according to the property.

7. The method of claim 6, wherein, during the training of the plurality of characterization layers, a parameter of the image generative model is fixed.

8. The method of claim 1, further comprising:
receiving the image generation command that is input via text or voice.

9. A processor-implemented method of training a characterization layer for personalized image generation, the method comprising:
training a preference prediction model based on a preference data set;
generating an output image corresponding to an image generation command from an image generative model based on a connection relationship between the image generative model and a characterization layer corresponding to one of a plurality of properties;
determine a score of a property for the output image using the preference prediction model; and
training a parameter of the characterization layer to maximize the score of the property.

10. The method of claim 9, wherein the training of the parameter of the characterization layer comprises:
fixing a parameter of the image generative model.

11. The method of claim 9, wherein the preference data set comprises a plurality of images output by the image generative model and the score of the property labeled on the plurality of images.

12. The method of claim 9, wherein the training of the parameter of the characterization layer comprises:
training the parameter of the characterization layer using one or more data sets of Pick-a-Pic, Human Preference Score, ImageReward, and CLIP-Aesthetics.

13. The method of claim 9, wherein the training of the parameter of the characterization layer comprises any one or any combination of any two or more of:
training the parameter of the characterization layer to maximize a score of a brightness property for an output of the image generative model;
training the parameter of the characterization layer to maximize a score of a saturation property for the output of the image generative model;
training the parameter of the characterization layer to maximize a score of a contrast property for the output of the image generative model; and
training the parameter of the characterization layer to maximize a score of an edge sharpness property for the output of the image generative model.

14. A non-transitory computer-readable storage medium storing code that, when executed by one or more processors, configures the one or more processors to perform the method of claim 1.

15. A device comprising:
one or more processors configured to:
obtain a preference vector of a user based on a plurality of properties predetermined for personalized image generation;
generate a personalized image for the user based on the preference vector and a connection relationship between an image generative model and a plurality of characterization layers corresponding to the plurality of properties; and
output the personalized image in response to an image generation command.

16. The device of claim 15, wherein the one or more processors are further configured to:
applying input data applied to a first layer comprised in the image generative model to a first characterization layer connected to the first layer in parallel, according to the connection relationship;
determining a weight of the first characterization layer according to the preference vector; and
aggregating an output of the first layer and an output of the first characterization layer based on the weight and transmitting an aggregated output to a next layer.

17. The device of claim 16, wherein the one or more processors are further configured to:
apply the input data applied to the first layer comprised in the image generative model to a second characterization layer connected to the first layer in parallel, according to the connection relationship;
determine a weight of the second characterization layer according to the preference vector; and
aggregate an output of the first layer and an output of the second characterization layer based on the weight and transmit an aggregated output to the next layer.

18. The device of claim 15, wherein the plurality of characterization layers comprises any one or any combination of any two or more of:
a layer trained to maximize a score of a brightness property for an output of the image generative model for an arbitrary text input;
a layer trained to maximize a score of a saturation property for the output of the image generative model for the arbitrary text input;
a layer trained to maximize a score of a contrast property for the output of the image generative model for the arbitrary text input; or
a layer trained to maximize a score of an edge sharpness property for the output of the image generative model for the arbitrary text input.

19. The device of claim 15, wherein the one or more processors are further configured to:
receive the image generation command that is input via text or voice.

20. The device of claim 15, wherein the one or more processors are further configured to set the preference vector by phases by repeating:
providing the user with a plurality of images generated with different weights with respect to the plurality of characterization layers; and
causing the user to select one from the plurality of images.
